(19) United States
(12) Patent Application Publication
(10) Pub. No.: US 2025/0330972 A1
(43) Pub. Date: Oct. 23, 2025

(54) PHYSICAL LAYER SCHEDULING FOR EXTENDED REALITY APPLICATIONS

(71) Applicant: ZTE CORPORATION, Shenzhen, Guangdong (CN)

(72) Inventors: Jianqiang DAI, Shenzhen, Guangdong (CN); Jun XU, Shenzhen, Guangdong (CN); Bo DAI, Shenzhen, Guangdong (CN); Mengzhu CHEN, Shenzhen, Guangdong (CN); Hong TANG, Shenzhen, Guangdong (CN)

(21) Appl. No.: 18/870,354

(22) PCT Filed: Aug. 10, 2022
(86) PCT No.: PCT/CN2022/111565

§ 371 Date: Nov. 27, 2024

(51) Int. Cl. H04W 72/12; H04L 1/1812; H04W 24/08; H04W 72/0453; H04W 72/11

(52) U.S. Cl. CPC H04W 72/12; H04L 1/1812; H04W 24/08; H04W 72/0453; H04W 72/11

(57) ABSTRACT

Methods, apparatus, and systems that relate to physical layer scheduling techniques are disclosed. In one example aspect, a method for wireless communication includes receiving, by a terminal device from a base station, a signaling message scheduling one or more transmissions associated with an extended reality application. The method also includes performing the one or more transmissions based on the signaling message.

### TECHNICAL FIELD

This patent document is directed to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to physical layer scheduling techniques that can be implemented to improve system capacity and reduce signaling overhead for extended Reality (XR) applications.

In one example aspect, a method for wireless communication includes receiving, by a terminal device from a base station, a signaling message scheduling one or more transmissions associated with an extended reality application. The method also includes performing the one or more transmissions based on the signaling message.

In another example aspect, a method for wireless communication includes transmitting, by a base station, a signaling message to a terminal device. The signaling message schedules one or more transmissions associated with an extended reality application to enable the terminal device to perform the one or more transmission.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates example transmissions scheduled by a conventional Downlink Control Information (DCI) signaling message.

FIG. 2 illustrates an example of frequency-domain sub-band scheduling by a single DCI signaling message in accordance with one or more embodiments of the present technology.

FIG. 3A is a flowchart representation of a method for wireless communication in accordance with one or more embodiments of the present technology.

FIG. 3B is a flowchart representation of a method for wireless communication in accordance with one or more embodiments of the present technology.

FIG. 4 illustrates an example grouping of transmissions based on slot numbers in accordance with one or more embodiments of the present technology.

FIG. 5 shows an example of a wireless communication system where techniques in accordance with one or more embodiments of the present technology can be applied.

FIG. 6 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

extended Reality (XR) is a term denotes Augmented Reality (AR), Mixed Reality (MR), and/or Virtual Reality (VR). The technology of XR combines real world and the virtual information generated by digital device. XR enables user perceived immersive experience in a mixed real-virtual environment. To support the high-quality XR service, the network is required to provide high date rate and low latency. For example, for downlink XR traffic (e.g., from the base station to user devices), a single stream can include video frames each having both left and right eye frame sharing the same buffer. Different types of multi-stream traffic (also referred to as multiple flows) can be used, such as video stream/flow and audio stream/flow, field of view (FOV) stream/flow and omnidirectional steam/flow. The packet success rate for XR traffic is usually required to be 99% or higher.

This patent application discloses various techniques that are applicable in wireless communication systems to improve bandwidth capacity and to reduce latency. In particular, considering the coherency and periodicity in XR traffic (e.g., several slots of XR frame need to be scheduled for a packet transmission to achieve date rate and capacity requirements), at the physical layer, a single Downlink Control Information (DCI) signaling message can schedule multiple transport blocks (TBs)/multiple transmissions to improve data rates and to reduce control signaling overhead. The user device can receive information (e.g., configuration or assistance information) from the network that indicates the service type of the data traffic (e.g., XR traffic). Once the user device determines that the upcoming transmission(s) are related to XR applications, it can be scheduled multiple transmission associated with the same XR traffic in a same signaling message, leading to better scheduling/transmission efficiency and lower overhead.

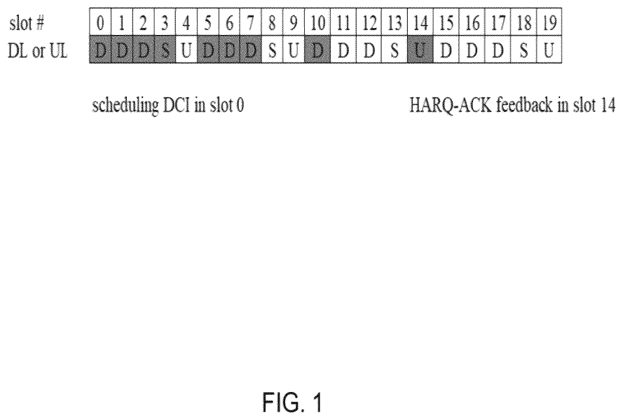

Currently, a DCI signaling message includes information about the Start and Length Indicator Value (SLIV), a Redundancy Version (RV), a New Data Indicator (NDI), and Modulation and Coding Scheme (MSC) for each transmission scheduled on the Physical Downlink Shared Channel (PDSCH). The current DCI design provides scheduling flexibility, but the flexibility also comes with a large signaling overhead. FIG. 1 illustrates example transmissions scheduled by a conventional DCI signaling message. A DCI signaling is transmitted in slot 0 in FIG. 1. If the maximum number of schedulable PDSCH transmissions is 8, up to 6 bits are needed for SLIV indication, up to 8 bits are needed for NDI indication (e.g., each bit corresponding to one scheduled PDSCH), and up to 8 bits are needed for RV indication (each bit corresponding to one scheduled PDSCH).

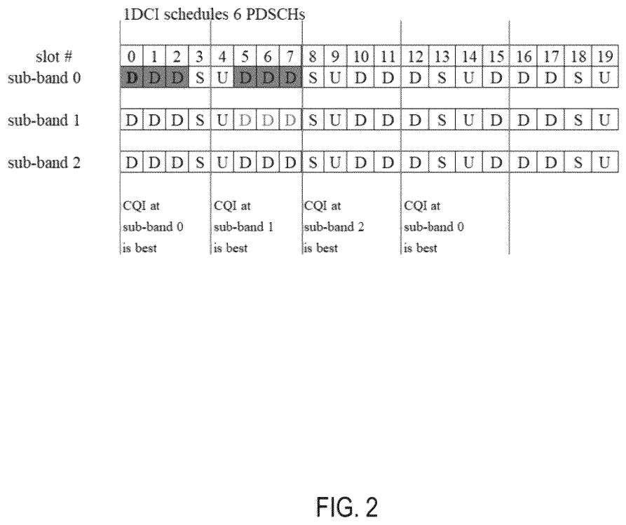

For XR traffic, the TB size in each scheduled transmission on the Physical Uplink Shared Channel (PUSCH) or the PDSCH can be similar. Furthermore, due to the low mobility of XR devices (e.g., the device typically stays in a same geographical location for a particular AR/VR session without much movement), the channel state for the transmissions can be similar. Therefore, it is also possible to configure the same SLIV, NDI, and/or RV for the scheduled PUSCHs/PDSCHs so as to reduce the signalling overhead. Furthermore, due to the frequency selective property of the wireless channel, enabling flexible frequency domain resource allocation to the user device (e.g., to select the frequency sub-band that has the best Channel Quality Indicator) can improve system capacity. FIG. 2 illustrates an example of frequency-domain sub-band scheduling by a single DCI signaling message in accordance with one or more embodiments of the present technology. The DCI signaling message schedules six transmission on the PDSCH. The CQI of sub-band 1 is the best in the associated time-domain slots. Thus, scheduling at least part of the PDSCH transmissions (e.g., the last three PDSCH transmission) in sub-band 1 can improve capacity.

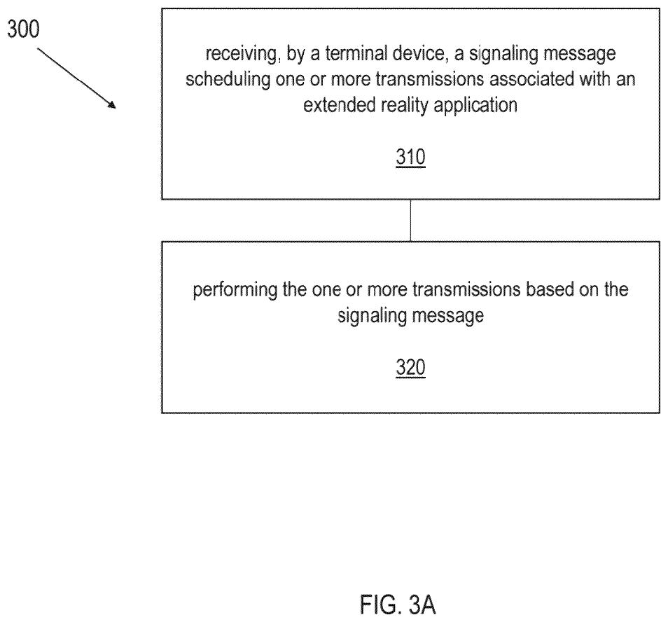

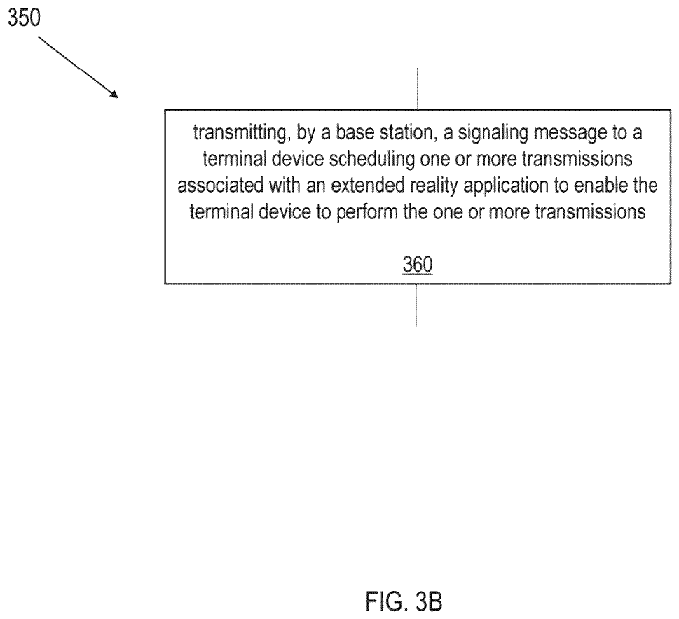

FIG. 3A is a flowchart representation of a method 300 for wireless communication in accordance with one or more embodiments of the present technology. The method 300 includes, at operation 310, receiving, by a terminal device, a signaling message scheduling one or more transmissions associated with an extended reality application. The method 300 includes, at operation 320, performing the one or more transmissions based on the signaling message. In some embodiments, the method includes receiving, by the terminal device, a second signaling message at a higher layer, the second singling message including information indicating traffic associated with the extended reality application.

FIG. 3B is a flowchart representation of a method 350 for wireless communication in accordance with one or more embodiments of the present technology. The method 350 includes, at operation 360, transmitting, by a base station, a signaling message to a terminal device scheduling one or more transmissions associated with an extended reality application to enable the terminal device to perform the one or more transmissions. In some embodiments, the method includes transmitting, by the base station, a second signaling message a higher layer, the second singling message including information indicating traffic associated with the extended reality application.

In some embodiments, the signaling message includes a field configured to indicate more than four monitoring adaptation options for the one or more transmissions.

In some embodiments, the signaling message is configured to schedule multiple transmissions associated with the extended reality application.

In some embodiments, the signaling message comprises information indicating multiple frequency-domain locations, each frequency-domain location configured for one of the multiple transmissions associated with the extended reality application. In some embodiments, the information comprises one or more offsets from a frequency domain resource. In some embodiments, the information comprises one or more hopping locations from a frequency domain resource. In some embodiments, the signaling message includes a bit field indicating that a preconfigured Configured Grant (CG) or Semi-Persistent Scheduling SPS resource is ignored or skipped.

In some embodiments, the signaling message includes group information indicating a number of groups that the multiple transmissions are organized into. In some embodiments, the group information includes one or more values indicating multiple time-domain durations, and wherein a subset of transmissions located in one of the multiple time-domain durations is categorized as a group. In some embodiments, the group information comprises a number of bits indicating the number of groups. In some embodiments, the group information comprises a number of bits indicating a number of transmissions in a group.

In some embodiments, a reduced number of bits is configured to indicate scheduling information for a subset of the multiple transmissions in a same group. In some embodiments, the scheduling information comprises an indicator indicating a last group of transport blocks for the multiple transmissions, a SLIV for a time-domain allocation of the multiple transmission, a redundancy version indicator, a new data indicator, a Hybrid Automatic Repeat Request (HARQ) process number, or a modulation and coding scheme.

In some embodiments, the multiple transmissions are configured for multiple media flows of the extended reality application. For example, a single DCI can schedule multiple TBs from multiple flows (e.g., FOV and omnidirectional flows), the DCI schedules eight TBs. Four of the eight TBs correspond to a first flow of XR traffic (e.g., FOV flow) and the four remaining TBs correspond to a second flow of XR traffic (e.g., omnidirectional flow). This way, additional signaling overhead with respect to multiple flows can be saved, allowing support for multi-flow scheduling even when resources on the Physical Downlink Control Channel (PDCCH) are limited at certain point in time.

Some examples of the disclosed techniques are further described below.

### Embodiment 1

In some embodiments, the UE receives information from the higher layer configuring or indicating the scheduling of XR traffic. In some embodiments, the base station can configure Semi-Persistent Scheduling (SPS), Configured Grant (CG) and/or Connected Discontinuous Reception (C-DRX) parameters to indicate whether the data service type can be XR data. In some embodiments, the information can be implemented as Quality of Service (QOS) assistance information. Example QoS assistance information can include at least one of the following:

1. Protocol Data Unit (PDU) Set Start Time.

2. Jitter of PDU Set Start Time.

3. PDU Set End Time or PDU Set Time Duration.

4. PDU Set Periodicity.

5. Packet periodicity or Packet numbers in one PDU Set.

6. Packet size.

7. PDU Set priority level.

8. PDU Set dependency information (e.g., whether PDU Set should be delivered in-sequence, and whether the subsequent PDU set delivery is not needed if its dependent PDU Set is lost).

In some embodiments, the information from the network can be implemented as User Plane General Packet Radio Services (GPRS) Tunneling Protocol (GTP-U) header assistance information. Example GTP-U header assistance information can include at least one of the following:

1. Start indication of a PDU set.

2. End indication of a PDU set.

3. PDU Set priority level.

4. PDU Set dependency information (e.g., whether PDU Set should be delivered in-sequence, and whether the subsequent PDU set delivery is not needed if its dependent PDU Set is lost).

Based on the higher layer configuration information, the UE can derive whether the subsequence traffic to be scheduled is XR traffic. In some embodiments, if the UE is configured to CG/SPS resource(s) but other configuration information indicates that XR traffic is to be scheduled, the DCI can include control information or a bit field to indicate that the preconfigured CG/SPS resource(s) can be ignored or skipped, and multiple XR transmissions are scheduled/performed based on the information indicated in the DCI.

In some embodiments, the UE can receive an explicit indication from the base station indicating whether scheduling of multiple XR traffic is configured. For example, a Radio Resource Control (RRC) Information Element (IE), such as pdsch-TimeDomainResourceAllocationListForMultiPDSCH-XR and/or pusch-TimeDomainResourceAllocationListForMultiPUSCH-XR can be used to indicate the multiple XR transmissions to be scheduled on PDSCH or PUSCH. In some embodiments, up to N entries can be indicated by the RRC IE, indicating that a DCI signaling can schedule up to N transmissions at a time. For example, N can be 16 or 32.

### Embodiment 2

In some embodiments, upon determining that XR traffic is to be scheduled (e.g., based on higher layer configuration information or explicit signaling), the UE can expect a single DCI signaling message carrying information to schedule multiple XR transmissions. The multiple XR transmission can further be scheduled to use multiple frequency domain resources so as to improve system capacity. To achieve so, the DCI signaling message can be enhanced using at least one of the following options.

Option 2-1: Enhanced DCI Format 0_1/DCI Format 1_1 for a single DCI scheduling multiple transmissions.

In this option, a new bit field (e.g., “frequency offset indication”) can be introduced to indicate a frequency offset from a starting or an end position of the assigned frequency domain resource(s). For example, as specified in the Third-Generation Partnership Project (3GPP) Technical Specification 38.212, the “frequency domain resource assignment” field indicates the location of the first frequency domain resource. The resource allocation type for XR transmissions is the same. Correspondingly, in some embodiments, a second frequency domain resource position can be indicated as an offset from the first frequency domain resource location.

Option 2-2: Enhanced Format 0_1 for a single DCI scheduling multiple uplink transmissions.

In some embodiments, frequency hopping can be configured for uplink transmissions on the PUSCH to reduce interference. Instead of having a single bit in the “frequency hopping indication” field to indicate whether hopping is enabled or disabled, the “frequency hopping indication” can be extended to multiple bits so as to indicate hop(s) based on the frequency domain resource(s) indicated by the “frequency domain resource assignment” field. Table 1 below shows an example frequency hopping indication in accordance with one or more embodiments of the present technology.

TABLE 1

| Bit field | |
|---|---|
| mapped to index | PUSCH frequency hopping |
| 0 | Disabled |
| 1 | First hop from the first frequency-domain resource |
| 2 | Second hop from the first frequency-domain resource |
| 3 | Third hop from the first frequency-domain resource |

Referring back to FIG. 2, with the enhanced DCI formats, more flexible scheduling (e.g., a frequency offset between first group and second group) can be configured based on the sub-band CSI, thereby improving system capacity.

### Embodiment 3

In some embodiments, TBs/transmissions associated with the XR traffic on the PUSCH/PDSCH can be grouped together. An enhanced DCI Format 0_1/DCI Format 1_1 that includes grouping information can be introduced. The grouping information can be indicated using at least one of the following options and/or a combination thereof:

Option 3-1: Indicating one or more slot values.

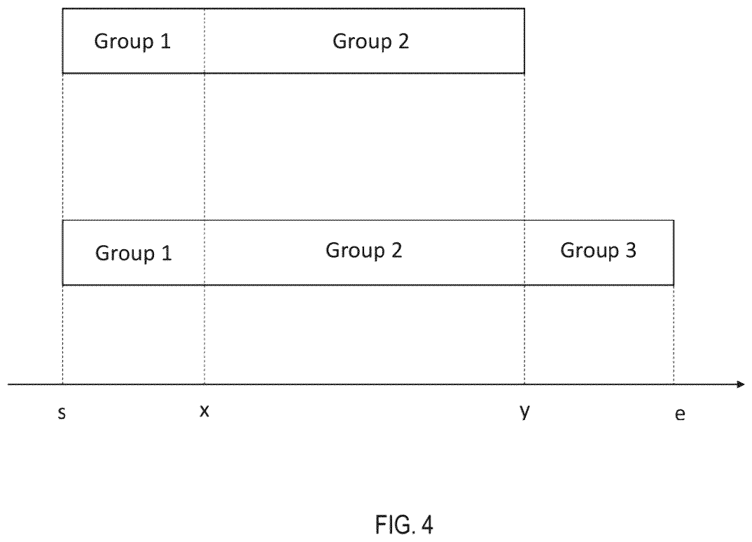

In this option, a new bit field (e.g., “PUSCH/PDSCH group information”) can be introduced to indicate the group information (e.g., PUSCH or PDSCH group information) using one or more slot values. FIG. 4 illustrates an example grouping of transmissions based on slot numbers in accordance with one or more embodiments of the present technology. The bit field “PUSCH/PDSCH group information” can indicate a first value for slot x and a second value for slot y. Based on the indicated values, the scheduled transmission can be divided into two or more groups. For example, if the slot number of the last scheduled transmission is smaller than or same as y, the transmissions are organized into two groups: the first group is from the starting slot s to slot x/x−1, and the second group is from slot x+1/x to the end slot (e or y). As another example, if the slot number of the last scheduled transmission is greater than y, the transmissions are organized into three groups: the first group is from the starting slot s to slot x/x−1, and the second group is from slot x+1/x to slot y/y−1, and the third group is from slot y+1/y to the last slot (e).

Option 3-2: Indicating the number of transmissions in each group.

In this option, a new bit field can be introduced to indicate the group information using a value that indicates the length of each group and/or the number of groups. For example, when the DCI includes log₂N bits to indicate a length of N, the first N transmissions belong to the first group, and the next N transmissions belong to the second group. In some embodiments, the number of groups can be determined based on ceil (maximum number of scheduled transmission/N). In some embodiments, the number of groups can be indicated by the DCI signaling.

### Embodiment 4

When multiple transmissions are scheduled together and/or multiple transmission are organized into a group, indicating that they are associated with the same XR traffic and share same channel condition characteristics, other fields in the DCI signaling message can be shortened to reduce signaling overhead (e.g., shortened bit field(s) in the DCI can be applied to each transmission in a group). Example fields can be shortened when multiple XR transmission are scheduled together include at least one of the following:

### Case 4-1: Shortened SLIV Field

Currently, up to 4 bits can be used for SLIV indication. When multiple XR transmissions are scheduled or organized into groups for XR traffic, the same SLIV value can be applied to the remaining transmissions or remaining transmission in the same group.

### Case 4-2: Shortened Time Domain Resource Assignment Field

Currently, up to 6 bits can be used for the time domain resource assignment indication. When the UE determines that multiple XR transmissions are scheduled or organized into groups for XR traffic, the bit width of the field time domain resource assignment can be reduced. For example, if the higher layer parameter pdsch-TimeDomainResourceAllocationListForMultiPDSCH-XR is configured, 0, 1, 2, 3, 4, or 5 bits as defined in Clause 5.1.2.1 of [6, TS38.214]. The bit width for this field is determined as [log₂(I)] bits, where I is the number of entries in the higher layer parameter pdsch-TimeDomainResourceAllocationListForMultiPDSCH-XR.

### Case 4-3: Shortened RV Field

When multiple XR transmissions are scheduled or organized into groups for XR traffic, the same RV value can be applied to the remaining transmissions or remaining transmission in the same group. For example, the number of bits of RV can be determined by the following:
2 bits if the number of scheduled transmissions indicated by the time domain resource assignment field is 1;
otherwise the number of bits determined by the maximum number of schedulable PDSCHs among all entries in the higher layer parameter pdsch-TimeDomainResourceAllocationListForMultiPDSCH-XR (e.g., log₂ (ceil (maximum number of schedulable PDSCHs/N)), where each bit corresponds to one group of transmissions and N indicates that the first N PDSCHs belong to the first group.

### Case 4-4: Shortened NDI Field

When multiple XR transmissions are scheduled or organized into groups for XR traffic, the same NDI value can be applied to the remaining transmissions or remaining transmission in the same group. For example, the number of bits of NDI can be determined by the following:
1 bit if the number of scheduled PDSCH indicated by the time domain resource assignment field is 1;
otherwise the number of bits determined by the maximum number of schedulable PDSCHs among all entries in the higher layer parameter pdsch-TimeDomainResourceAllocationListForMultiPDSCH-XR (e.g., log₂ (ceil (maximum number of schedulable PDSCHs/N)), where each bit corresponds to one group of transmissions and N indicates that the first N PDSCHs belong to the first group.

### Case 4-5: Shortened HARQ Process Number

For transmissions grouped for XR traffic, having a smaller HARQ process number can reduce processing complexity. For example, the number of bits of NDI can be specified by the following:
5 bits if higher layer parameter harq-ProcessNumberSizeDCI-1-1 is configured;
3 bits if the higher layer parameter pdsch-TimeDomainResourceAllocationListForMultiPDSCH-XR is configured, with each group of PDSCHs having the same HARQ process number;
otherwise, 4 bits.

### Case 4-6: Shortened MCS Value

When multiple XR transmissions are scheduled or organized into groups for XR traffic, same or similar MSC value can be applied to the remaining transmissions or remaining transmission in the same group. The DCI signaling message can be enhanced using at least one of the following options.

Option 4-6-1: a new bit field “MCS offset information” can be introduced to indicate an index offset from the MCS indicated by bit field “modulation and coding scheme.” For example, the field “modulation and coding scheme” indicates a value of 2, the MCS used by the first group of PDSCHs is indicated by the value 2. The bit field “MCS offset information” indicates an offset value of 1. The MCS used by the second group of PDSCHs is thus indicated by value 2+1=3.

Option 4-6-2: The DCI can indicate a row index of a MCS configuration table.

In some embodiments, a table of MCS values can be configured via RRC signaling. Table 2 shows example values that can be configured by RRC signaling.

TABLE 2

| Row | | |
|---|---|---|
| Index | Group #1 | Group #2 |
| 1 | MCS #N1 | MCS #N2 |
| 2 | MCS #N3 | MCS #N4 |
| 3 | MCS #N5 | MCS #N6 |
| 4 | MCS #N7 | MCS #N8 |
| . . . | | |

As shown in Table 2, each row of the configuration includes a MCS value for group #1 and a group #2. MCS values for additional groups can also be configured if more groups are supported. The DCI bit field can include a row index indicating the applicable MCS values for each group of the transmissions. In some embodiments, the bit field “modulation and coding scheme” can be reused to indicate the row index.

Option 4-6-3: The DCI can include a second MSC bit field to indicate the MCS for other group(s) of transmissions. An example second MCS bit field can be the following:
5 bits indicate the MCS of second group of PDSCHs/PUSCHs.

### Option 4-7: Shortened Indication of Last Group of TBs

In some embodiments, a bit field (e.g., “last group of TBs”) can be used to indicate which transmission/TB is the last so that the UE can stop C-DRX timer(s) (e.g., OnDuration timer and/or Inactivity timer) if the C-DRX is configured. For example, eight transmissions are scheduled, and three bits are needed to indicate which of the eight transmissions is the last transmission. When the transmissions are organized in groups, fewer bits are needed for the indication. For example, if the eight transmissions are organized as four groups, only two bits are needed to indicate which group is the last group of TBs.

### Embodiment 5

In some embodiments, the UE can adapt its monitoring behavior for the PDCCH to achieve power saving. The PDCCH monitoring adaption field allows UE to switch PDCCH monitoring behavior with a sparser PDCCH monitoring occasions within one Bandwidth Part (BWP) when data arrives sparsely. Currently, the PDCCH monitoring adaption indication is limited to be 0, 1, or 2 bits. However, given that XR traffic's periodic nature and that multiple XR transmissions can be scheduled at the same time, more flexibility can be provided in UE's PDCCH monitoring behavior so as to improve its power saving features. In some embodiments, three or more bits can be used for PDCCH monitoring adaptation indication (e.g., together with the shortened DCI bits as discussed in Embodiment 4) so that the UE can have more diverse monitoring behaviors to save power. The enhanced PDCCH monitoring adaptation indication can be applied to a single transmission as well as multiple transmissions. In some cases, UE is expected to monitor PDCCH for scheduled re-transmission(s) during the PDCCH skipping duration. In other cases, the UE is expected to monitor PDCCH for scheduled re-transmission(s) when drx-retransmission Timer is running and the time is within the PDCCH skipping duration. In this regard, the enhanced PDCCH monitoring adaptation can improve the system capacity.

It is noted that the techniques described on the above embodiments focus in the scheduling of a single flow of XR traffic, but they can also be applied to multi-flow XR traffic scheduling.

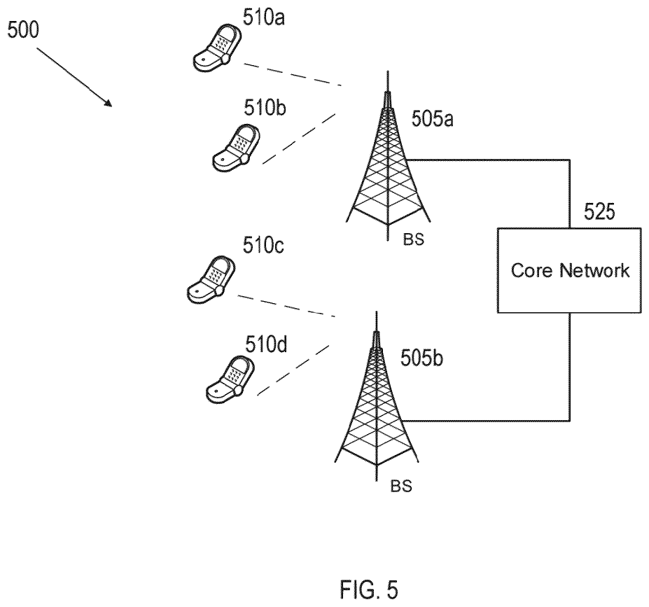

FIG. 5 shows an example of a wireless communication system 500 where techniques in accordance with one or more embodiments of the present technology can be applied. A wireless communication system 500 can include one or more base stations (BSs) 505a, 505b, one or more wireless devices (or UEs) 510a, 510b, 510c, 510d, and a core network 525. A base station 505a, 505b can provide wireless service to user devices 510a, 510b, 510c and 510d in one or more wireless sectors. In some implementations, a base station 505a, 505b includes directional antennas to produce two or more directional beams to provide wireless coverage in different sectors. The core network 525 can communicate with one or more base stations 505a, 505b. The core network 525 provides connectivity with other wireless communication systems and wired communication systems. The core network may include one or more service subscription databases to store information related to the subscribed user devices or terminal devices 510a, 510b, 510c, and 510d. A first base station 505a can provide wireless service based on a first radio access technology, whereas a second base station 505b can provide wireless service based on a second radio access technology. The base stations 505a and 505b may be co-located or may be separately installed in the field according to the deployment scenario. The user devices 510a, 510b, 510c, and 510d can support multiple different radio access technologies. The techniques and embodiments described in the present document may be implemented by the base stations of wireless devices described in the present document.

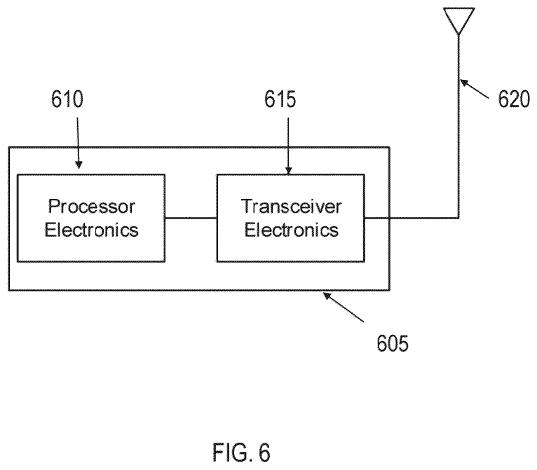

FIG. 6 is a block diagram representation of a portion of a radio station in accordance with one or more embodiments of the present technology can be applied. A radio station 605 such as a network node, a base station, or a wireless device (or a user device, UE) can include processor electronics 610 such as a microprocessor that implements one or more of the wireless techniques presented in this document. The radio station 605 can include transceiver electronics 615 to send and/or receive wireless signals over one or more communication interfaces such as antenna 620. The radio station 605 can include other communication interfaces for transmitting and receiving data. Radio station 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules or functions are implemented using the radio station 605. In some embodiments, the radio station 605 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A method for wireless communications, comprising:
receiving, by a terminal device from a base station, a signaling message scheduling one or more transmissions associated with an extended reality application; and
performing the one or more transmissions based on the signaling message.

2. The method of claim 1, comprising:
receiving, by the terminal device, a second signaling message at a higher layer, the second signaling message including information indicating traffic associated with the extended reality application.

3. A method for wireless communications, comprising:
transmitting, by a base station, a signaling message to a terminal device, wherein the signaling message schedules one or more transmissions associated with an extended reality application to enable the terminal device to perform the one or more transmissions.

4. The method of claim 3, comprising:
transmitting, by the base station, a second signaling message a higher layer, the second signaling message including information indicating traffic associated with the extended reality application.

5. The method of claim 1, wherein the signaling message includes a field configured to indicate more than four monitoring adaptation options for the one or more transmissions.

6. The method of claim 1, wherein the signaling message is configured to schedule multiple transmissions associated with the extended reality application.

7. The method of claim 1, wherein the signaling message comprises information indicating one or more frequency-domain locations, each frequency-domain location configured for one of the one or more transmissions associated with the extended reality application.

8. The method of claim 7, wherein the information comprises one or more offsets from a frequency domain resource.

9. The method of claim 7, wherein the information comprises one or more hopping locations from a frequency domain resource.

10. The method of claim 1, wherein the signaling message includes a bit field indicating that a preconfigured Configured Grant called CG or Semi-Persistent Scheduling SPS resource is ignored or skipped.

11. The method of claim 1, wherein the signaling message includes group information indicating a number of groups that multiple transmissions are organized into.

12. The method of claim 11, wherein the group information includes one or more values indicating multiple time-domain durations, and wherein a subset of transmissions located in one of the multiple time-domain durations is categorized as a group.

13. The method of claim 11, wherein the group information comprises a number of bits indicating a number of groups.

14. The method of claim 11, wherein the group information comprises a number of bits indicating a number of transmissions in a group.

15. The method of claim 11, wherein a reduced number of bits is configured to indicate scheduling information for a subset of the multiple transmissions in a same group.

16. The method of claim 15, wherein the scheduling information comprises an indicator indicating a last group of transport blocks for the multiple transmissions, a Start and Length Indicator called SLIV for a time-domain allocation of the multiple transmissions, a redundancy version indicator, a new data indicator, a Hybrid Automatic Repeat Request called HARQ process number, or a modulation and coding scheme.

17. The method of claim 1, wherein multiple transmissions are configured for multiple media flows of the extended reality application.

18. A communication apparatus, comprising a processor configured to implement a method of claim 1.

19. A computer program product having code stored thereon, the code, when executed by a processor, causing the processor to implement a method of claim 1.

20. The method of claim 3, wherein the signaling message includes a field configured to indicate more than four monitoring adaptation options for the one or more transmissions.
